(19) United States
(12) Patent Application Publication
(10) Pub. No.: US 2008/0102747 A1
(43) Pub. Date: May 1, 2008

(54) SSL-Based Mobile Virtual Private Networking Solution

(76) Inventors: Mohammed Didarul Alam, Plano, TX (US); Nachiket Acharya, Bellevue, WA (US)

Correspondence Address: CONLEY ROSE, P.C., 5601 GRANITE PARKWAY, SUITE 750, PLANO, TX, 75024, US

(21) Appl. No.: 11/554,671

(22) Filed: Oct. 31, 2006

(51) Int. Cl. H04H 1/00

(52) U.S. Cl. 455/3.05

(57) ABSTRACT

A system for a mobile handset to access an organization infrastructure is provided. The system includes an organization system within the organization infrastructure that is operable to maintain data for a user, such as email messages. The system includes an aggregator that is operable to aggregate at least some of the data for the user from the organization system. The system also includes a client on the mobile handset to communicate with the aggregator to receive at least some of the data.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to mobile telecommunications devices. More specifically, but not by way of limitation, a system is described that provides for the use of a mobile telecommunications device with limited resources to connect to an email account via a virtual private network.

### BACKGROUND OF THE INVENTION

A virtual private network (VPN) can allow access into an enterprise's computing system from a remote location. A user logging in to a computing system via a VPN might have a similar level of access to the computing system as if the user were logged directly into the computing system. For example, an employee might log in from a home computer to a corporate VPN and gain the same access to the employee's corporate email account and corporate documents that the employee would have when physically present in the corporation's offices.

### SUMMARY OF THE INVENTION

In one embodiment, a system for a mobile handset to access an organization infrastructure is provided. The system includes an organization system within the organization infrastructure that is operable to maintain data for a user, such as email messages. The system includes an aggregator that is operable to aggregate at least some of the data for the user from the organization system. The system also includes a client on the mobile handset to communicate with the aggregator to receive at least some of the data.

In another embodiment, a low-end mobile handset is provided to obtain email messages from an organization infrastructure. The low-end mobile handset includes a display and a client. The display is operable to display email messages. The client is operable on the low-end mobile handset to communicate with an aggregator that aggregates email from the organization infrastructure. The aggregator and client are operable for communication via a virtual private network (VPN).

In another embodiment, a method is provided for displaying on a low-end mobile handset, through a virtual private network, data stored within a corporate infrastructure. The method includes an aggregator aggregating data from the corporate infrastructure for use by the low-end mobile handset. The method includes the aggregator authenticating a use associated with the low-end mobile handset. The low-end mobile handset accesses the corporate infrastructure via a virtual private network (VPN). The aggregator providing access to the VPN. The method includes the corporate infrastructure communicating data to the aggregator. The method includes the aggregator communicating data to a client on the low-end mobile handset, and the client displaying the data on a display of the low-end mobile handset.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a system for accessing a VPN via a mobile handset according to an embodiment of the present disclosure.

FIG. 2 illustrates a method for accessing a VPN via a mobile handset according to an embodiment of the present disclosure.

FIG. 3 illustrates a block diagram of a mobile handset operable for some of the various embodiments of the present disclosure.

FIG. 4 illustrates an exemplary general purpose computer system suitable for implementing the several embodiments of the disclosure

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

In a traditional VPN, a user typically logs on to a desktop or laptop computer and connects to the VPN via a wired telephone line. As mobile telecommunications devices, such as wireless mobile telephones, have become more sophisticated, some mobile telephones have gained the capability to communicate wirelessly with the Internet in addition to being able to communicate with a telecommunications network. Such mobile telephones might be used to connect to a VPN. However, the capability to connect to a VPN would typically be present only on what might be referred to as high-end telephones, that is, telephones with large memory capacities and elevated levels of other resources. The large memory capacity on such a telephone might allow email that is accessed through a VPN to be downloaded to and stored on the telephone. An email client, such as Microsoft Outlook, might be installed on the telephone to provide access to email functions. Low-end mobile telephones, i.e., mobile telephones that have a relatively small amount of memory and other resources relative to their more robust counterparts, are typically not capable of executing such large email clients or storing large quantities of email messages.

Embodiments of the present disclosure provide for the connection of a low-end mobile telephone to a VPN. Email messages can be retrieved through the VPN and temporarily stored for viewing on a low-end telephone. A server that can be referred to as a VPN aggregator acts as an intermediary between the mobile telephone and the VPN. A thin client installed on the mobile telephone allows a user to log in to the VPN aggregator. The VPN aggregator then communicates, via the VPN, with an add-in to an email client within a corporate infrastructure. The VPN aggregator retrieves email from the email client add-in and returns the email to the thin client on the mobile handset. The email can then be viewed on the mobile handset.

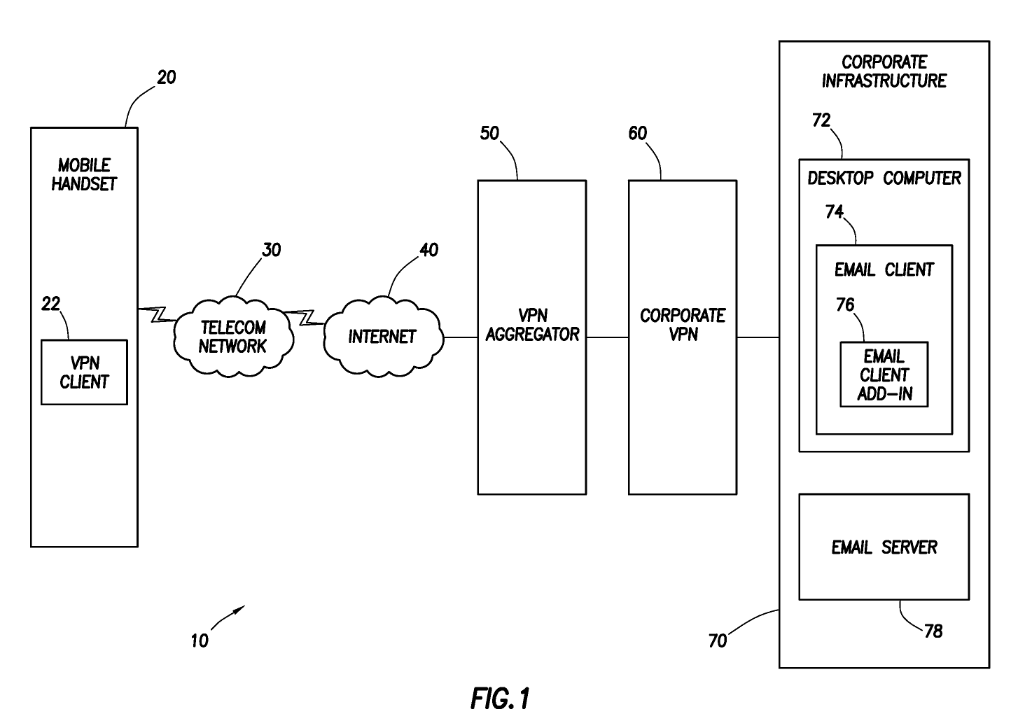

FIG. 1 illustrates an embodiment of a system 10 for using a low-end mobile handset 20 to access a corporate VPN 60 via a VPN aggregator 50. The handset 20 might be a mobile telephone, a personal digital assistant, or a similar device that is capable of connecting to a telecommunications network but that has limited processing and memory resources. For example, the mobile handset 20 might be a low-end or low-resource mobile handset and not have sufficient resources to run Microsoft Outlook or other robust systems that can communicate directly with email servers, and desktop application to receive and/or send email. The mobile handset 20 includes a VPN client 22, which is a software module that allows a user to use the mobile handset 20 to view email that is stored within a corporate infrastructure 70. The VPN client 22 causes a user interface to appear in the display of the mobile handset 20 into which the user can enter information that enables connection to the VPN aggregator 50. In an embodiment, the information that the user enters is a user ID, a password, and a hostname/IP address for the VPN aggregator 50.

The VPN client 22 causes the handset 20 to send the user ID, password, and IP address wirelessly to a wireless telecommunications network 30, such as a CDMA network, GSM network, or other well known network for wireless telephony. The telecommunications network 30 relays the user ID and password, via the Internet 40, to the VPN aggregator 50 that has the IP address entered by the user. Secure login via the handset 20 to the VPN aggregator 50 might be handled by Internet Protocol Security (IPsec) or a similar network security protocol. Communication between the handset 20 and the VPN aggregator 50 might be over a Secure Sockets Layer (SSL) connection or a similar connection. The VPN aggregator 50 authenticates the user ID and password with the corporate VPN 60 and, upon authentication, allows the user to log in to the corporate VPN 60. The VPN aggregator 50 then acts as a proxy for communication between the VPN client 22 and the corporate VPN 60. That is, the VPN aggregator 50 can translate requests coming from the VPN client 22 into industry-compliant VPN requests understandable by the corporate VPN 60. The VPN aggregator 50 can also translate industry-compliant VPN responses coming from the corporate VPN 60 into responses understandable by the VPN client 22. The VPN aggregator 50 may be thought of, for example, as doing the heavy processing and storing to reduce the demands on the client 22 to enable the client 22 to operate on low-end or low-resource mobile handsets. The VPN aggregator 50 might be managed by the telecommunications company that operates the telecommunications network 30, by the company that manufactured the mobile handset 20, or by some other entity.

The corporate VPN 60 might be a VPN that a corporation has previously set up to provide users with remote access to the corporate infrastructure 70 in the traditional manner or might be a VPN that has been set up specifically to allow access via low-end mobile telephones such as the handset 20. The corporate VPN 60 might be managed by the entity that manages the corporate infrastructure 70 or the management of the corporate VPN 60 might be outsourced to an outside party.

After logging in to the corporate VPN 60, the user can gain access to the corporate infrastructure 70, which might include a plurality of desktop computers 72, a plurality of email servers 78, and other components. More specifically, the user might gain remote access to the desktop computer 72 to which the user typically has physical access when present on the premises of the corporation that maintains the corporate infrastructure 70. It should be understood that the term “desktop computer” might refer to a laptop computer, a handheld computer, or some other computing device capable of performing the functions typically carried out by traditional desktop computers. Also, it should be understood that the term “corporate infrastructure” does not necessarily pertain only to a for-profit corporation but could refer to the infrastructure of any entity that controls access to one or more desktop computers 72 and one or more email servers 78.

The desktop computer 72 to which the user gains access might include an email client 74, such as Microsoft Outlook or a similar application. The email client 74 provides an interface for managing email that is routed through the email server 78, which might be an Exchange server for example. In an embodiment, the email client 74 includes an add-in 76 that can synchronize events between the email client 74 and the VPN aggregator 50. The email client add-in 76 can cause email that is present on the email client 74 to be sent, via the corporate VPN 60, to the VPN aggregator 50. The VPN aggregator 50 then sends the email, via the Internet 40 and the telecommunications network 30, to the mobile handset 20. The VPN client 22 on the mobile handset 20 can display email messages received in this manner on the screen of the handset 20. In this way, the user can use the mobile handset 20 to view email that is present on the user's desktop computer 72.

This manner of viewing email that is on the email client 74 might require that the user's desktop computer 72 be turned on and that the user be logged on to the email client 74. In an alternative embodiment, the user does not need to be logged on to the email client 74. Instead, the user might log directly into the email server 78 via the corporate VPN 60. An email message could then be sent from the email server 78, via the corporate VPN 60, the VPN aggregator 50, the Internet 40, and the telecommunications network 30, to the mobile handset 20. The VPN client 22 on the handset 20 could then display the email message on the screen of the handset 20.

An email message that is viewed on the handset 20 is stored on the handset 20 only while the message is being viewed. When the user closes the display of the message, the message is deleted from the storage location on the handset 20 where the message was temporarily maintained for viewing purposes. This temporary storage of email messages allows the use of only a minimal amount of memory capacity on the handset 20 while messages are being viewed.

In an embodiment, the VPN aggregator 50 stores email messages locally for retrieval by the handset 20. Alternatively, messages can be stored on the email server 78 and pushed or pulled from there to the VPN aggregator 50 and then to the handset 20. When a message is deleted from the handset 20, the message remains on the VPN aggregator 50 or on the email server 78.

In an embodiment, the handset 20 can pull email messages from the VPN aggregator 50 or the email server 78. That is, the user can use the handset 20 to request that a message be displayed on the handset 20. Alternatively, the email client add-in 76 can push messages to the handset 20 when the email client add-in 76 is informed of the arrival of new email. The email client add-in 76 might send an alert to the handset 20 when a new email message arrives and the user might open the email message at any time after receiving the alert. Alternatively, the email client add-in 76 can simply send the new email message to the handset 20 without sending an alert.

In an embodiment, a new menu, tab, or other interface is created in the email client 74 to display the email client add-in 76. Similarly, a new menu, tab, or other interface is created in the screen of the handset 20 to facilitate the display of email messages in the handset 20 by the VPN client 22.

While the above discussion has focused only on the display of email messages on the mobile handset 20, in other embodiments the VPN client 22 might provide the capability to compose and reply to email messages. Sending messages from the mobile handset 20 might require greater computing capacity than simply displaying messages, but might still be possible on a low-end mobile telephone.

In the setup process to allow a user to gain access to the corporate VPN 60 through the handset 20, the user might enter into the email client add-in 76 his or her user ID and the IP address for the VPN aggregator 50 associated with the corporate VPN 60. Thereafter, when the user enters the user ID and IP address into the VPN client 22 on the handset 20, the user can log in, via the VPN aggregator 50 and the corporate VPN 60, to the email client 74 on the desktop computer 72.

While only one VPN aggregator 50, one corporate VPN 60, and one corporate infrastructure 70 are shown in FIG. 1, other numbers and combinations of these components could be present. For example, a single user might be granted access to several different corporate infrastructures 70 and each corporate infrastructure 70 might be accessed through a different corporate VPN 60. Also, a single VPN aggregator 50 might allow access to several different corporate VPNs 60. In addition, although not shown in FIG. 1, firewalls or other security features would typically be present between at least some of the elements in the figure, such as between the Internet 40 and the VPN aggregator 50.

In an embodiment, when a user has access to multiple corporate infrastructures 70, a VPN aggregator similar to the VPN aggregator 50 is associated with each corporate VPN 70 to which the user has access. To set up access to multiple VPN aggregators 50, the user might enter the IP address of each VPN aggregator 50 into an email client add-in 76 within each corporate infrastructure 70. Thereafter, when the user wishes to log in to one of the VPN aggregators 50, the user might enter the IP address of the desired VPN aggregator 50 into the VPN client 22. The user would then be given access only to the corporate infrastructure 70 associated with the VPN aggregator 50 to which the user was logged in.

While the above description has focused on an email application, it should be understood that this system could also be used for calendar events, task management, or other applications. For example, the email client 74 might include a calendar or a task manager or a calendar or task manager might be present on the desktop computer 72 independently of the email client 74. A user might be able to retrieve calendar events and/or tasks from the desktop computer 72 using the handset 20 in a manner similar to the manner described above for email messages. Alternatively, calendar events and/or task reminders might be automatically sent from the desktop computer 72 to the handset 20 at appropriate times. Simple text-based documents might also be retrieved via this system. One of skill in the art will recognize other applications that might make use of this system.

For tasks that require synchronization with the desktop computer 72, such as automatic notification of an impending calendar event or automatic notification of the arrival of a new email, the user typically needs to be logged on to the desktop computer 72 independently of being logged on to the VPN aggregator 50. For viewing of old emails or simple text-based documents, the user does not necessarily need to be logged on to the desktop computer 72. The user might go directly to the email server 78 for simple email retrieval or to a file server within the corporate infrastructure 70 for retrieval of text-based documents.

The system described above allows a user to use a low-end mobile telephone to gain access to many of the functions that are typically available on the office computer used by the user. That is, a mobile telephone with small amounts of memory capacity and other resources can be used to read email, retrieve small files, and receive notifications of the arrival of email messages and calendar events. This system can also reduce battery consumption on a mobile telephone since the amount of time required to download data to the mobile telephone is reduced compared to devices that store data after messages have been viewed.

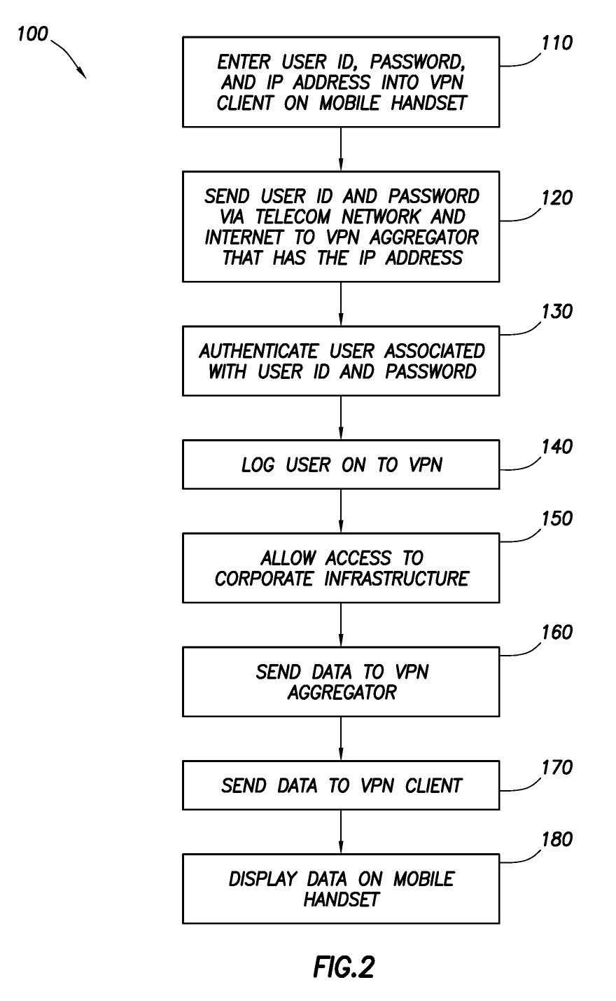

FIG. 2 illustrates a method 100 for using a low-end mobile handset to log in to a VPN and, via the VPN, view data stored within a corporate infrastructure. In box 110, a user enters a user ID, password, and IP address into a VPN client on the mobile handset. In box 120, the VPN client sends the user ID and password via a telecommunications network and the Internet to a VPN aggregator that has the IP address that was entered into the mobile handset. In box 130, the VPN aggregator uses the user ID and password to authenticate the user. Upon authenticating the user, the VPN aggregator logs the user on to the VPN in box 140. In box 150, the VPN allows the user access to the corporate infrastructure. In box 160, the corporate infrastructure sends the data to the VPN aggregator. In box 170, the VPN aggregator sends the data to the VPN client. In box 180, the VPN client displays the data on the mobile handset.

The system described above may be implemented on any handheld mobile electronic device 20 such as is well known to those skilled in the art. An exemplary mobile handset system 20 for implementing one or more embodiments disclosed herein is illustrated in FIG. 3. The mobile handset 20 includes a processor 1210 (which may be referred to as a central processor unit or CPU) that is coupled to a first storage area 1220, a second storage area 1230, an input device 1240 such as a keypad, and an output device such as a display screen 1250.

The processor 1210 may be implemented as one or more CPU chips and may execute instructions, codes, computer programs, or scripts that it accesses from the first storage area 1220 or the second storage area 1230. The first storage area 1220 might be a non-volatile memory such as flash memory. The second storage area 1230 might be firmware or a similar type of memory.

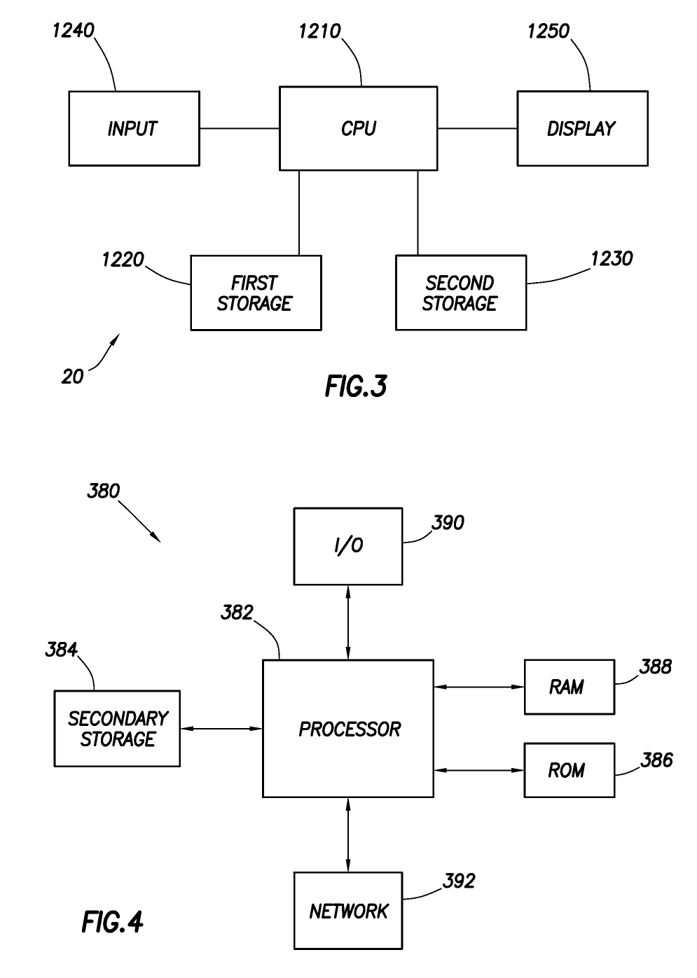

The system described above, for example the VPN aggregator 50 and/or desktop computer 72, may be implemented on any general-purpose computer with sufficient processing power, memory resources, and network throughput capability to handle the necessary workload placed upon it. FIG. 4 illustrates a typical, general-purpose computer system suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) 390 devices, and network connectivity devices 392. The processor may be implemented as one or more CPU chips.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage. The RAM 388 is used to store volatile data and perhaps to store instructions. Access to both ROM 386 and RAM 388 is typically faster than to secondary storage 384.

I/O 390 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 392 devices may enable the processor 382 to communicate with an Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity 392 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for a mobile handset to access an organization infrastructure, comprising:
an organization system within the organization infrastructure operable to maintain data for a user;
an aggregator operable to aggregate at least some of the data for the user from the organization system; and
a client operable on the mobile handset to communicate with the aggregator to receive at least some of the data.

2. The system of claim 1, wherein the data is an email message.

3. The system of claim 2, wherein the mobile handset is a low-end mobile handset.

4. The system of claim 2, wherein the aggregator aggregates the user's email messages from the organization system, and wherein the client received the emails messages from the aggregator.

5. The system of claim 4, wherein the client is operable only for viewing the email messages and wherein the email messages are not stored on the mobile handset for subsequent retrieval.

6. The system of claim 1, wherein the client is further defined as a VPN (virtual private network) client on a low-end mobile handset, the VPN client operable to receive a user ID, a password, and an IP address entered into the low-end mobile handset, the VPN client further operable to display the data for the user on the low-end mobile handset; and wherein the VPN aggregator is at the IP address and wherein the VPN aggregator is operable to receive the user ID and password, authenticate a user associated with the user ID and password, and, upon authentication, log the client onto the virtual private network, the virtual private network providing access to the organization infrastructure.

7. The system of claim 2, wherein an add-in to an email client within the organization infrastructure system promotes communication of email to the aggregator.

8. The system of claim 2, wherein an email server within the organization infrastructure promotes communicate of the email message to the aggregator.

9. The system of claim 1, wherein the aggregator is operable to convert a data transmission from the client into an industry-compliant VPN (virtual private network) request and to convert an industry-compliant VPN response into a data transmission understandable by the client.

10. A low-end mobile handset to obtain email messages from an organization infrastructure, comprising:
a display operable to display email messages;
a client operable on the low-end mobile handset to communicate with an aggregator that aggregates email from the organization infrastructure, the aggregator and client operable for communication via a virtual private network (VPN).

11. The system of claim 10, wherein the client is operable only for displaying the email messages to the display for viewing the email messages and wherein the email messages are not stored on the low-end mobile handset for subsequent retrieval.

12. The system of claim 11, wherein an interface to the client is displayed on the low-end mobile handset.

13. The system of claim 11, wherein communication between the low-end mobile handset and the aggregator is over a connection at least as secure as a Secure Sockets Layer connection.

14. A method for displaying on a low-end mobile handset, through a virtual private network, data stored within a corporate infrastructure, comprising:
an aggregator aggregating data from the corporate infrastructure for use by the low-end mobile handset;
the aggregator authenticating a use associated with the low-end mobile handset;
the low-end mobile handset accesses the corporate infrastructure via a virtual private network (VPN), the aggregator providing access to the VPN;
the corporate infrastructure communicating data to the aggregator;
the aggregator communicating data to a client on the low-end mobile handset; and
the client displaying the data on a display of the low-end mobile handset.

15. The method of claim 14, further comprising storing the data on the low-end mobile handset only while the data is being displayed.

16. The method of claim 14, further comprising the aggregator converting a data transmission from the client into an industry-compliant VPN request and converting an industry-compliant VPN response into a data transmission understandable by the client.

17. The method of claim 14, wherein the data is an email message.

18. The method of claim 14, wherein providing access to the corporate infrastructure includes logging onto an add-in to an email client in the corporate infrastructure, and wherein sending the data to the aggregator comprises the add-in sending the data.

19. The method of claim 18, further comprising the add-in to the email client sending an alert to the low-end mobile handset when an email message arrives in the email client.

20. The method of claim 14, wherein providing access to the corporate infrastructure includes logging onto an email server in the corporate infrastructure, and wherein sending the data to the aggregator comprises the email server sending the data.
